(19) United States
(12) Patent Application Publication
(10) Pub. No.: US 2021/0043101 A1
(43) Pub. Date: Feb. 11, 2021

(54) METHOD AND DEVICE FOR PROVIDING LEARNING CONTENT USING AI TUTOR

(71) Applicant: RIIID INC., Seoul (KR)

(72) Inventors: Kyung Hoon KIM, Seoul (KR); Min Sung NOH, Seoul (KR); Jae We HEO, Seoul (KR); Kyung Yeol KIM, Seoul (KR); Jin Seo YOON, Seoul (KR); Young Sun KIM, Seoul (KR)

(21) Appl. No.: 16/978,594

(22) PCT Filed: Jun. 14, 2018
(86) PCT No.: PCT/KR2018/006693

§ 371 Date: Sep. 4, 2020

(30) Foreign Application Priority Data
Mar. 5, 2018 (KR) 10-2018-0025532

(51) Int. Cl. G09B 7/08; G06F 3/0488; G06N 20/00; G06Q 50/20

(52) U.S. Cl. CPC G09B 7/08; G06Q 50/20; G06N 20/00; G06F 3/04886

(57) ABSTRACT

The present disclosure relates to a method and device for providing questions for learning. According to the present disclosure, a method by which a server provides questions for question includes step a of displaying learning content on a first region of a screen displayed on a terminal of a learner; step b of fixedly displaying an AI object on a second region of the screen; step c of determining whether a learning progress of the learner satisfies a predetermined object activation condition; and step d of displaying an AI message corresponding to the object activation condition on a third region of the screen adjacent to the AI object while the AI object is activated, when the learning progress satisfies the object activation condition. According to the present disclosure, a user interface may be adaptively changed according to a question solving situation of a learner, thereby inducing continuous learning of a user.

### TECHNICAL FIELD

The present disclosure relates to a method and device for providing learning content and, more particularly, to a method and device for providing learning content using an AI tutor in order to dynamically provide motivation in response to a learner's question solving and to induce learner enthusiasm.

### BACKGROUND ART

Recently, the Internet and electronic devices have been actively utilized in various fields, and the education environment has also rapidly changed to incorporate such devices. In particular, the development of various educational media has enabled learners to select and use a wider range of learning methods. Among them, an education service over the Internet has become a major teaching and learning tool because it overcomes time and space constraints and enables low cost education.

In response to this trend, customized education services that are not available in offline education due to limited human and material resources are now diversified. For example, by providing level-specific learning segmentalized according to the personality and abilities of learners, learning content according to the individual competence of the learners may be provided beyond the rigidly standardized education in the past.

However, even in this customized educational service, most of the educational content provided so far relies on one-sided cramming education methods. In other words, if an instructor provides a lecture according to the learner's level, the learner who took the lecture goes through a separate learning process offline, and then confirms the learning outcomes through an evaluation process. In this way, the educational service provided so far through the Internet is not different from the conventional offline teaching method in that the learning outcomes depend on the offline effort of the learner taking the lecture. Furthermore, the above-described educational service is not able to utilize its function efficiently in the Internet education environment where the interactive education is possible in order to improve the learner's practical ability.

In particular, although online learning is expanding as described above, the online learning is conducted mainly in lectures and is not efficiently used in mock tests and question solving.

Online mock tests currently on the market may be generally divided into a test paper area 30a that copies an offline questionnaire as is and an answer sheet area 30b in which only the answer can be checked to thereby provide questions as shown in FIG. 1A, or may establish a user interface capable of receiving a selection input through a check box 30c arranged in front of an actual multiple choice option number while having the same format as that of the offline questionnaire as shown in FIG. 1B.

The online question solving learning content in the manner shown in FIG. 1B is disclosed in Korean Patent Publication No. 10-2016-0014335 (Title of the disclosure: computer-readable medium recording program for authoring online learning contents and method of authoring online learning contents, publication date: Feb. 11, 2016).

This display method is a method of merely displaying an offline questionnaire online, and it is hard to say that it offers a special function that only online learning can have. Because of this, online use of content such as mock tests and question solving is done poorly.

Therefore, there is a demand for a method for more efficiently displaying questions so that online learning can be utilized for question solving beyond simple lectures, and of inducing learner motivation.

### DETAILED DESCRIPTION OF THE INVENTION

### Technical Problem

Therefore, the present disclosure has been made in view of the above-mentioned problems, and an aspect of the present disclosure is to provide a method and device for providing questions for learning, in which displaying questions and options may be optimized for online learning so that question solving can be efficiently performed online.

Another aspect of the present disclosure is to provide a question display method which may continuously provide learning motivation to a learner to compensate disadvantages of web-based learning in which the learner can be easily distracted.

Still another aspect of the present disclosure is to provide an adaptive user interface that changes according to a learner's question solving situation to induce user's learning.

### Technical Solution

In accordance with an aspect of the present disclosure, a method by which a server provides questions through a webpage includes: step a of displaying a question solving time on one fixed region of an upper end of the webpage; step b of displaying a predetermined first target number of questions versus the number of solved questions on the one fixed region of the upper end of the webpage; step c of displaying a text object including character text, picture text, or voice text on a first content display region of the webpage; step d of displaying one or more question objects composed of questions and options on a second content display region adjacent to one side of the first content display region; and step e of floating a progress request button at a lower end of the webpage, wherein the step b includes comparing the number of solved questions and the first target number of questions when the progress request button is selected, and switching and displaying the display on the one fixed region to a predetermined second target number of questions versus the number of solved questions when the number of solved questions achieves or exceeds the first target number of questions based on the comparison result.

In accordance with another aspect of the present disclosure, a device for providing questions for learning includes: a storage unit configured to store learning content, an AI object, and an AI message; a UI generation unit configured to generate a user interface for displaying the learning content, the AI object, and the AI message in a webpage or an application program; and a communication unit configured to transmit the learning content, the AI object, and the AI message, which are displayed according to the user interface, to a terminal of a learner, wherein the UI generation unit sets the user interface to display a question solving time on one fixed region of an upper end of the webpage, to display a predetermined first target number of questions versus the number of solved questions on the one fixed region of the upper end of the webpage, to display one or more text objects including character text, picture text, or voice text on a first content display region of the webpage, to display one or more question objects including at least one of questions and options on a second content display region adjacent to one side of the first content display region, to float a progress request button at a lower end of the webpage, to compare the number of solved questions and the first target number of questions when the progress request button is selected, and to switch and display the display on the one region to a predetermined second target number of questions versus the number of solved questions when the number of solved questions achieves or exceeds the first target number of questions based on the comparison result.

### Effects of the invention

As described above, according to the present disclosure, it is possible to provide a method for displaying questions and options optimized for online learning.

According to the present disclosure, it is possible to induce continuous learning from a learner and provide motivation to the learner, thereby solving a disadvantage of web-based learning in which the learner can be easily distracted.

Also, according to the present disclosure, a user interface may be adaptively changed in accordance with a question solving situation of a learner, thereby inducing user's continuous learning.

### BRIEF DESCRIPTION OF THE DRAWINGS

FIG. 1 is a diagram illustrating a conventional method for displaying online learning content;

FIG. 2 is a diagram illustrating a device for providing questions for learning according to an embodiment of the present disclosure and an operating environment thereof;

FIG. 3 is a diagram illustrating an AI objet and an AI message according to an embodiment of the present disclosure;

FIG. 4 is a diagram illustrating an AI message after a diagnostic test is completed according to an embodiment of the present disclosure;

FIG. 5 is a diagram illustrating a question loading screen according to an embodiment of the present disclosure;

FIG. 6 is a diagram illustrating an AI message in a case in which a previous question solving time is 3 seconds or less according to an embodiment of the present disclosure;

FIG. 7 is a diagram illustrating a learning suggestion AI message according to an embodiment of the present disclosure;

FIG. 8 is a diagram illustrating an AI message when a predicted score is changed according to an embodiment of the present disclosure;

FIG. 9 is a diagram illustrating an AI message when a predicted score reaches a goal score according to an embodiment of the present disclosure;

FIG. 10 is a diagram illustrating an AI message when learning is terminated according to an embodiment of the present disclosure;

FIG. 11 is a diagram illustrating a method for displaying content of a webpage according to an embodiment of the present disclosure;

FIG. 12 is a diagram illustrating a method of displaying a target number of questions versus the number of solved questions according to an embodiment of the present disclosure;

FIG. 13 is a diagram illustrating a display method in a question solving mode according to an embodiment of the present disclosure;

FIG. 14 is a diagram illustrating a method for displaying a question including a picture and a voice according to an embodiment of the present disclosure;

FIG. 15 is a diagram illustrating a question including voice text according to an embodiment of the present disclosure;

FIG. 16 is a diagram illustrating information displayed on a second content display region depending on whether an option selected by a learner is correct or incorrect according to an embodiment of the present disclosure; and

FIG. 17 is a diagram illustrating an embodiment of a case in which an object activation condition is satisfied by a result obtained by analyzing a learning progress of a learner during solving question solving content according to the present disclosure.

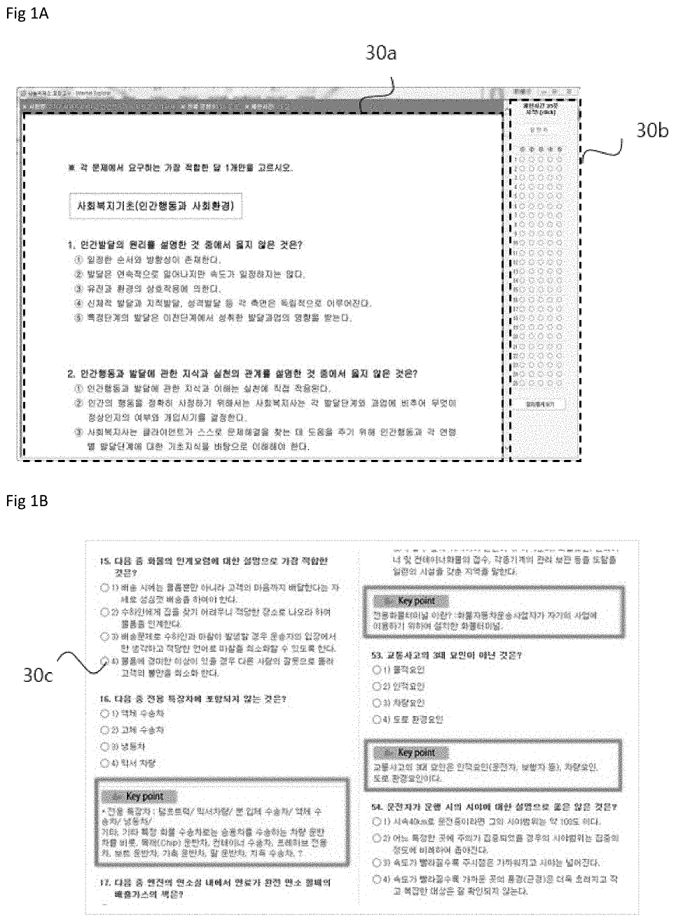

### MODE FOR CARRYING OUT THE INVENTION

The above objects, features, and advantages will be described in detail with reference to the accompanying drawings and therefore, the technical ideas of the present disclosure can be easily practiced by a person with ordinary skill in the art to which the present disclosure pertains. Further, when it is determined that the detailed description of the known art related to the present disclosure may obscure the gist of the present disclosure, the detailed description thereof will be omitted. Hereinafter, preferred embodiments of the present disclosure will be described in detail with reference to the accompanying drawings. In the drawings, the same reference numerals are used to designate the same or similar components, and all combinations described in the specification and claims can be combined in any manner. As used herein, the singular forms are intended to include the plural forms as well, unless the context clearly indicates otherwise.

In the present specification, the term “question solving mode” refers to a state in which a learner can listen to or read text and questions and can select options, and the term “scoring mode” refers to a state in which a result or interpretation of an option selected by a learner is provided.

In addition, in the present specification, a “text object” is an independent object representing text and can be classified into character text, picture text, and voice text depending on its characteristics. The “character text” refers to text given to solve a question, the “picture text” refers to a picture given to solve a question, and the “voice text” refers to a voice given to solve a question. In a case of a listening question in which both a question and options are voice, it can be understood that the “voice text” may also include a voice associated with the options.

A “question object” is an object that is composed of question and/or option and can receive an option selection input of a user, and is a concept corresponding to one question. Throughout the specification of the present disclosure, a “question” refers to content composed of text and options, and it can be understood that the “question” is a concept that includes both a “single question” in which one question is associated with one block of text and a “combination question or group question” in which a plurality of questions are associated with one block of text.

“Learning content” is a concept that includes all content comprehensively utilized for learning, may be content composed for each topic (noun, verb, adverb, preposition, grammar, listening, writing, reading, sentence type, etc.) and for each question type (part 1, part 2, . . . , of the TOEIC, etc.,), and can be classified according to a learning method (question solving, video lecture, text lecture, etc.). That is, the learning content is a concept that includes question solving content, lecture content, etc. In this specification, for example, an embodiment of a case in which “question solving content” composed of one or more questions is provided is described. In another embodiment, the learning content is divided into a text object and a question object.

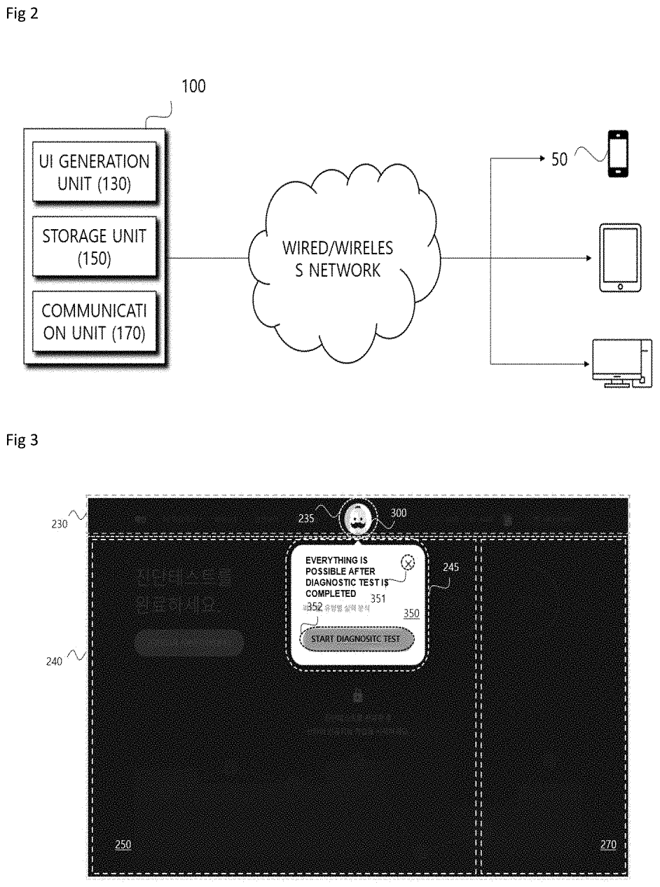

Hereinafter, a device for providing questions for learning according to an embodiment of the present disclosure will be described with reference to FIG. 2.

FIG. 2 is a diagram illustrating a device 100 for providing questions for learning according to an embodiment of the present disclosure and an operating environment thereof.

The device 100 according to the present disclosure may be a server that includes a UI generation unit 130, a storage unit 150, and a communication unit 170, and may further include a learner management unit 190. The device 100 may provide questions to a terminal 50 of a learner through a wired/wireless network, and the terminal 50 may identify the questions through an application program installed in a web browser or the terminal 50.

The UI generation unit 130 generates a user interface capable of efficiently providing question solving and learning content stored in the storage unit 150. The question solving and the learning content may include foreign language test questions such as TOEIC, TOEFL, IELTS, JLPT, HSK, etc., and may include subject-specific study material questions for elementary, middle, and high school students. In the present specification, an embodiment of a case in which TOEIC test questions are provided through a webpage will be mainly described, but the present disclosure is not limited to the contents and kinds of questions.

The UI generation unit 130 may configure a webpage as follows to provide questions through the webpage.

As an example, as shown in FIG. 3, the UI generation unit 130 may display learning content on a first region 240 of a screen displayed on a terminal of a learner in step a, may fixedly display an AI object 300 on a second region 235 of the screen in step b, may determine whether a learning progress of the learner satisfies a predetermined object activation condition in step c, when a learner input is received from the terminal, and may set a user interface in step d in such a manner that an AI message 350 corresponding to the object activation condition is displayed on a third region 245 of the screen adjacent to the AI object 300 while the AI object 300 is activated when the learning progress satisfies the object activation condition. Here, the first region may be displayed on a layer different from those of the second region and the third region.

The AI message 350 may include one or more action objects for receiving a learner input. Here, a server 100 may deactivate the AI object when an input for selecting a first action object 351 deactivating an AI object 300a is received from the terminal 50, and may display first learning content on a first region when an input for selecting a second action object 352 corresponding to the first learning content stored in advance in the server 100 is received from the terminal 50. In the embodiment of FIG. 3, when clicking on the first action object 351 (close), the learner may temporarily deactivate the AI object and may perform a desired operation on the original screen. When the learner clicks on the second action object 352 (start a diagnostic test), a first question and options of the diagnostic test may be displayed on the first region 240. When the learning progress satisfies a plurality of conditions and one or more AI messages corresponding to the condition exist, the AI message may be set to be sequentially displayed on the third region according to a predetermined priority.

Hereinafter, in the method for displaying questions for learning according to an embodiment of the present disclosure, an implementation example of the AI object 300 and the AI message 350 will be described in more detail. (For convenience of description, the UI generation unit 130 is indicated as a server)

The AI object is an image that is fixedly displayed on one region of the screen, and functions as a kind of artificial intelligence tutor that manages a learning progress of a learner. In a case in which a learner input such as switching of the screen occurs, it is assumed that the learner wants to ask a question. At this time, when there is a change in the learning progress of the learner, the AI object may be activated and an AI message corresponding to the activated AI object may be provided, so that the learner may feel that interaction and management are continuously performed. The AI object and the AI message may provide content and a message most suitable for the situation of the learner at every moment, and may suggest question solving content, lecture content, etc. to the learner if necessary. This is different from the conventional method of providing messages in the order periodically or non-periodically stored in a table, and it is possible to provide the learner with much greater motivation and achievement in that the AI object and the AI message operate intelligently based on the learner input and the learner progress.

First, in step c, the UI generation unit 130 changes the display on the first region 240 when a learner input is received from the terminal. The learner input may occur by a learner selecting a random action object through an input interface (mouse, touch panel, keyboard, speaker, camera, etc.) provided in the terminal. The action object is an object displayed on the screen so as to select a screen transition or a content change in a webpage or an application program, and includes a button, an icon, an image, text, and the like corresponding to a link or a predetermined input value. For example, the learner input may include an input by the learner selecting a specific learning item using the mouse, pressing a backward button, or selecting one of a plurality of options to submit an answer.

In step c, the UI generation unit 130 i) may determine that the object activation condition is satisfied when the display on the first region is changed, or ii) may determine that the object activation condition is satisfied when a learning result of the learner is changed by the learner input. Alternatively, iii) the object activation condition may be satisfied by a result obtained by analyzing the learning progress of the learner by the learner management unit 190.

### Recommend Learning Area (Part) on Main Screen

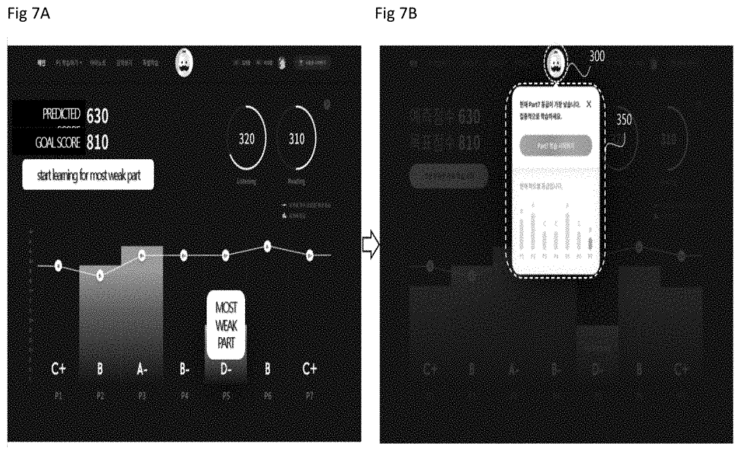

Embodiments of i) will be considered. Referring to FIG. 7, when the display on the first region is changed to a main screen indicating achievement for each learning area of the learner by selecting a “main item” by a user as shown in FIG. 7A, the UI generation unit 130 may activate the AI object 300 as shown in FIG. 7B, and may display a message for recommending the learning area having the lowest achievement in the AI message 350.

### Change in Predicted Score or Predicted Score Reaching Goal Score

The embodiments of ii) will be considered. The learning result that can be changed by the learner input may include a predicted score calculated using a question solving result of the learner, whether the predicted score reaches a predetermined goal score of the learner, whether the question solving result of the learner is correct or incorrect, achievement for each learning area of the learner calculated using the question solving result of the learner, grade information of the learner calculated using the question solving result of the learner, or a correct answer probability of a next question calculated using the question solving result of the learner.

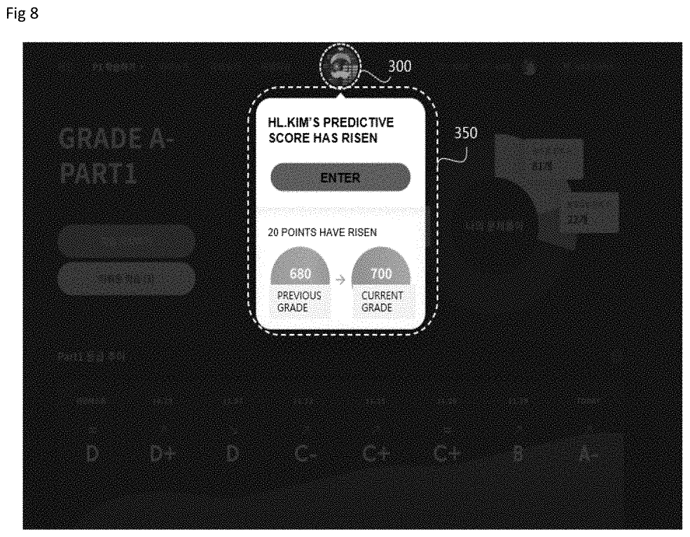

For example, when the learning of the question solving content is completed by the learner input, the predicted score of the learner calculated using the question solving result may be changed. For example, when the predicted score of the learner is calculated as 680 points as shown in FIG. 8 through a diagnostic test, it may be determined that the achievement of a weakness area becomes higher based on a result obtained by learning specific question solving content, and therefore the predicted score may be changed. When the predicted score is changed, the UI generation unit 130 may display the fact that the predicted score is changed and the changed predicted score in the AI message 350.

Operations of calculating the predicted score using the question solving result of the learner and re-calculating the predicted score whenever a new question solving result is updated may be performed by the learner management unit 190. The learner management unit 190 calculates the predicted score using question solving data collected through a diagnostic test using machine learning. In addition, whenever the predicted score is updated, a goal score received from the learner and the predicted score may be compared to provide the compared result to the UI generation unit 130, so that the UI generation unit 130 may allow the learner to display the predicted score, whether the predicted score reaches the goal score, and the like.

In addition, the learner management unit 190 may manage the achievement for each learning area with respect to each learner, may calculate the grade of the learner using the question solving result of the learner, and may calculate a probability that an answer to each question present in a question database (storage unit) is correct, using the achievement for each learning area of the learner, a correct answer probability for the question, and the like.

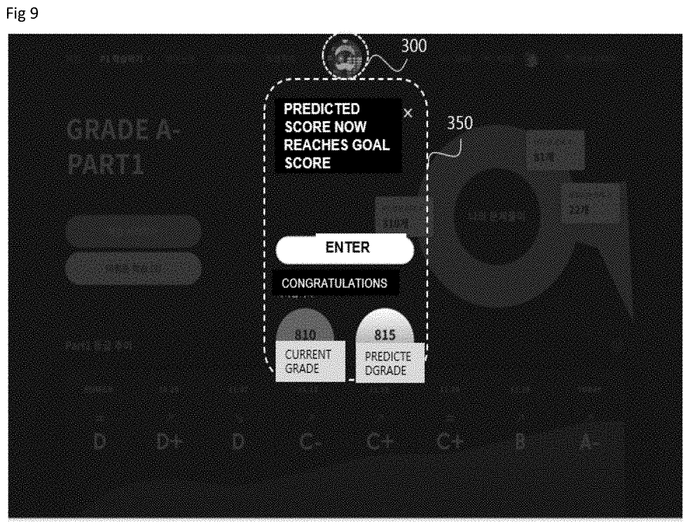

As another embodiment, when the predicted score of the learner is raised to reach the goal score, the AI object 300 may be activated, and the UI generation unit 130 may display the fact that the predicted score reaches the goal score as shown in FIG. 9 in the AI message 350.

### Case in which Learning Content is Question Solving Content

Assuming that the learning content is the question solving content, in step c, the UI generation unit 130 may determine that the first activation condition is satisfied when an answer to a first question is input from the terminal, and the AI message corresponding to the first object activation condition may include at least one of a loading message of a next question, whether the answer is correct or incorrect, achievement for each learning area of the learner calculated using whether the answer is correct or incorrect, grade information of the learner calculated using whether the answer is correct or incorrect, a weak learning area of the learner calculated using whether the answer is correct or incorrect, a name of a recommended lecture corresponding to the weak learning area, and a link of the recommended lecture.

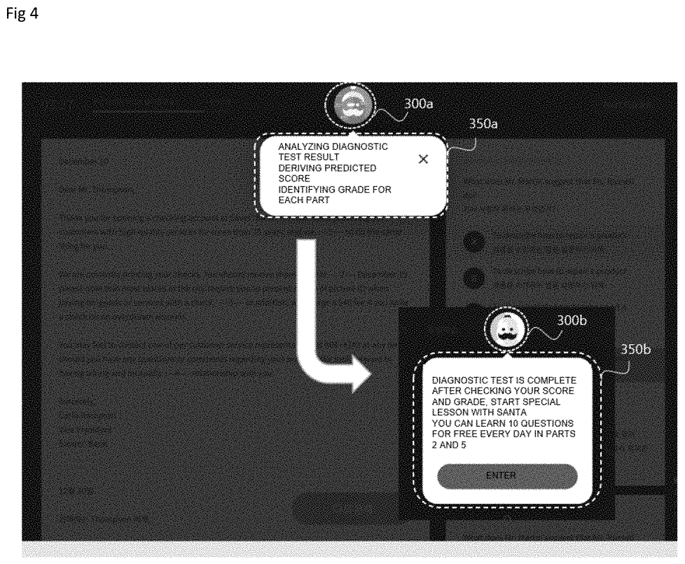

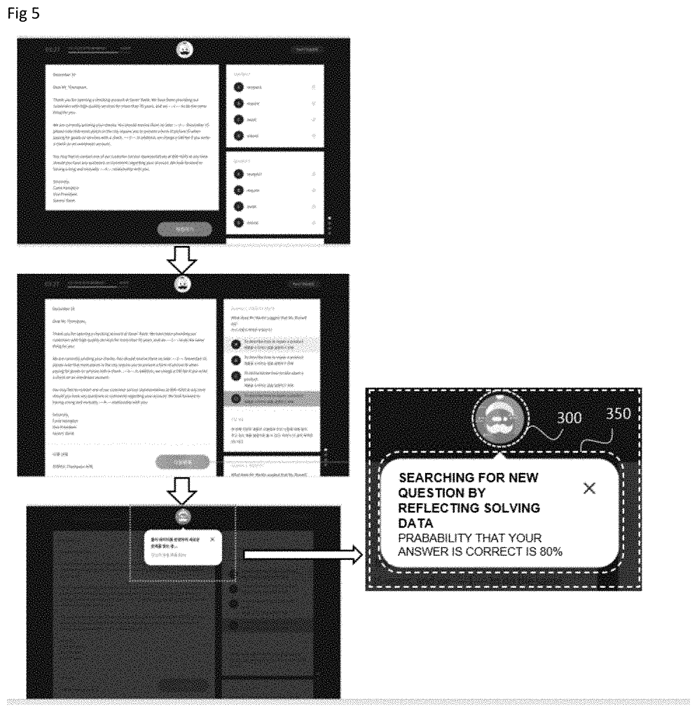

For example, as shown in FIG. 4, when an answer to a final question of the diagnostic test is input by the learner, the UI generation unit 130 may display AI messages 350a, such as “analyzing a diagnostic test result . . . , deriving the predicted score . . . , and identifying the grade for each part”, sequentially or at a time. After the diagnostic test is completed, it may take a long time for the learner management unit 190 to analyze the diagnostic test result, to derive the predicted score, and to calculate the grade for each part. The fact that a corresponding question is being loaded may be displayed in the AI message, so that the learner may identify which operation is performed by the server 100. When the loading is completed, an AI message 350b may indicate that the diagnostic test has been completed and may display the score and the grade on the first region of the screen.

As another embodiment, when the learner inputs an answer to one of questions included in the question solving content as shown in FIG. 5, the server 100 may search for a new question by reflecting solving data, and may calculate a probability that an answer to a next question is correct by reflecting whether the answer is correct or incorrect to thereby display the AI message 350 together with the loading message.

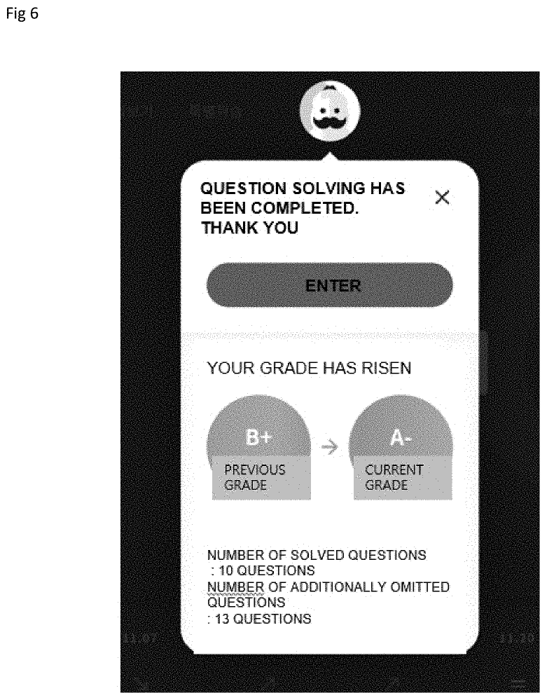

As another embodiment, when the learner inputs an answer to a final question of the question solving content including one or more questions as shown in FIG. 6, the learning of the corresponding question solving content is terminated, and the UI generation unit 130 may display grade information of the learner calculated using whether an answer of the question included in the question solving content is correct or incorrect, together with a question solving completion message, and solving result statistic information of the question solving content (the number of questions solved by the learner among all questions included the question solving content, the number of questions included in the question solving content but omitted due to difficulty adjustment according to a user's answer input in a solving process, etc.).

FIG. 17 is a diagram illustrating an embodiment of iii) in which an object activation condition is satisfied by a result obtained by analyzing a learning progress of a learner by the learner management unit 190 during solving question solving content. For example, during solving a question, when it is analyzed that an incorrect answer is consistently generated from a question highly associated with a noun, the learner management unit 190 may individually calculate achievement of each learning element according to which learning elements each question includes and whether the answer for the corresponding question is correct or incorrect. The learner management unit 190 may analyze that a weakness type has been found. When the server 100 intelligently and actively analyzes the learning progress and the result is derived (regardless of the learner input), the AI object 300 may display the weak learning area, a recommended lecture name corresponding to the weak learning area, a link of the recommended lecture, predicted grade information, and the like in the AI message 350, as shown in FIG. 17. However, the embodiment of iii) may be considered substantially the same as the embodiment of ii) in which the object activation condition is satisfied by the learner input. This is because the server 100 continuously receives the learner input from the terminal in the learner's learning process and learner's learning situation data is updated by the received input (content selection, correct/incorrect answer input, etc.).

### Inducing Diagnostic Test

The object activation condition may be variously generated according to setting of a developer. As another embodiment that is not included in the above-described classification, in step c, the UI generation unit 130 may identify whether the diagnostic test result of the learner exists in the database (storage unit 170) when the learner input is a new question learning request. When the diagnostic test result of the learner does not exist in the database, it may be determined that a second object activation condition for inducing the diagnostic test is satisfied. At this time, an AI message corresponding to the second object activation condition may include a message for inducting the diagnostic test and an action object executing the diagnostic test.

The device 100 for providing questions for learning according to an embodiment of the present disclosure provides learner-customized questions based on the learner's diagnostic test results, and thus it is necessary to collect diagnostic test solving results first. Accordingly, when a new question learning request input is received from the learner, the UI generation unit 130 may first identify whether the learner performs the diagnostic test. Next, the AI message 350 for inducing the diagnostic test may be displayed on the third region as shown in FIG. 3. The AI message 350 for inducing the diagnostic test may include a link (action object) that can directly start diagnostic test content, thereby inducing a user to perform the diagnostic test immediately.

### Inducing Delayed Learning

As another embodiment of the object activation condition, when a new learning content start input is received from the terminal in a state in which the first learning content that has not been completed exists, it may be determined that a third object activation condition is satisfied. In this case, an AI message satisfying the third object activation condition may include a message for inducing learning of the first learning content and an action object executing the first learning content.

According to an embodiment of the present disclosure, the learner may execute and stop each piece of learning content, and the learning categories are recorded and managed by the learner management unit 190 and stored in the storage unit 170. Therefore, when an input for starting new question solving content or an input for reproducing new lecture content is received from the terminal in a state in which unsolved question solving content exists or lecture content whose reproduction has not been completed until the end of the reproduction exists, the UI generation unit 130 may display a message for encouraging the learner to complete the learning content that has not been completed on the AI message, and may display an action object (a delayed learning content execution link) on the AI message so that the corresponding learning content can be directly executed even if it is not directly found and executed.

### Case in which Question Solving Time is too Short

In a case in which the learning content is the question solving content, the UI generation unit 130 may display a random question on the first region, and may determine that a fourth object activation condition is satisfied when a time at which an answer to the question is input is a predetermined reference value or less. In this case, an AI message corresponding to the fourth object activation condition may include an alarm message about a solving speed.

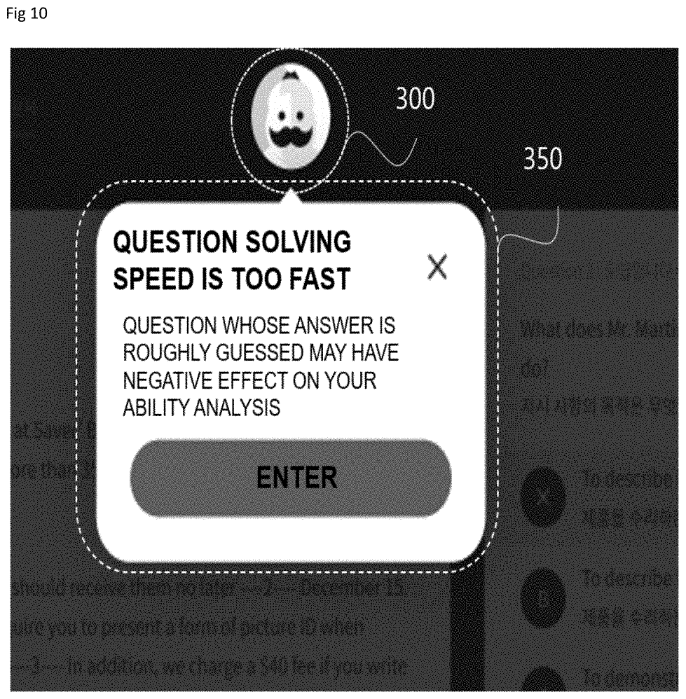

Referring to an example of FIG. 10, when the question solving time is 3 seconds or less, an alarm message indicating that “question solving speed is too fast” may be displayed on the AI message 350. Since the fact that the question solving time is too short has a probability that the learner roughly guesses the answer without solving the corresponding question, the UI generation unit 130 may awaken the alert by generating an AI message so that the learner may generate an AI message so that the learner can solve the question without roughly guessing the answer, thereby promoting awareness.

Hereinafter, a method for displaying questions for learning other than the AI object 300 and the AI message 350 in a webpage and an application program will be described in detail.

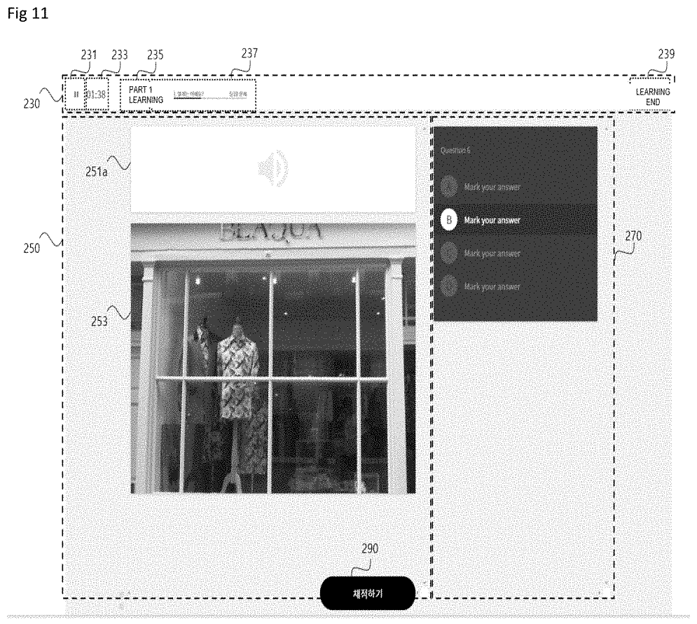

The UI generation unit 130 may display a question solving time on one fixed region 233 of an upper end of a webpage (screen) as shown in FIG. 11, and may display a predetermined first target number of questions versus the number of solved questions on one fixed region 237 of the upper end of the webpage.

The UI generation unit 130 may additionally display a pause button of the question solving time and a count playback button thereof on the one fixed region 231 of the upper end of the webpage, and may display characteristic information of a question on another fixed region 235 of the upper end of the webpage. The characteristic information of the question may be upper category information of the question displayed on the webpage, such as a unit (part) to which the question belongs, the type of the question, the characteristics of the question, and the like.

Further, the UI generation unit 130 may include a learning end button on one fixed region 239 of the upper end of the webpage. When the learning end button is pressed, switching from a current screen to an initial screen may be performed at any time. When an input for selecting the learning end button is received, the device 100 for providing questions for learning may store a current learning position of the learner in the storage unit 150 together with identification information of the learner and part information of the question, and then may allow the learner to subsequently solve the question that has been solved by the learner in the corresponding part.

In general, the one region 230 of the upper end of the webpage is called a header, and is a frame structure that is equally shown in all pages. The UI generation unit 130 of the present disclosure may display the above-described information in the header region so that the learner can check the question solving situation.

The question solving time 233 plays a role of helping a learner who has to solve a lot of questions within a predetermined time to check and adjust a time for solving the questions. The question solving time may be set to be counted up or down in the question solving mode, and so as not to be counted in the scoring mode.

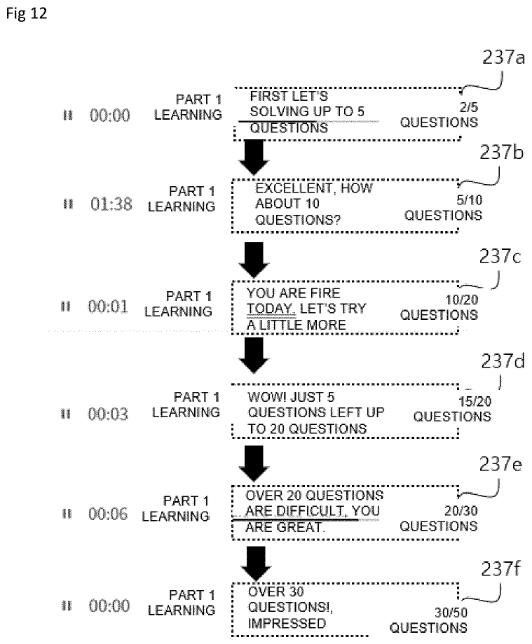

Meanwhile, the first target number of questions versus the number of solved questions displayed on the one region 237 may be set to be adaptively changed according to question solving of the learner. For example, when a progress request button 290 is selected, the UI generation unit 130 may compare the number of solved questions and the first target number of questions. Next, when the number of solved questions achieves or exceeds the first target number of questions based on the comparison result, the display on the one region may be switched and displayed to a predetermined second target number of questions versus the number of solved questions. Referring to FIG. 12, the target number of questions is set to be 5 as an initial value, and the 5 questions versus the number (two) of questions that have been solved so far may be displayed as indicated by 237a. In particular, by providing the target number of questions versus the number of solved questions with a bar or a graphic through which a ratio can be checked such as a graph, the learner can intuitively check a goal achievement rate.

When the number of solved question is 5 or greater, the display on the one region may be switched to a display using 10 questions as the target number of questions as indicated by 237b. In this manner, the target number of questions may be increased to 5 questions->10 questions->15 questions->20 questions->30 questions->50 questions, which makes it possible for the learner to feel the sense of accomplishment of achieving the goal.

The above-described user interface is based on a learning principle in which a short-term goal is set to achieve a higher achievement rate. In addition, as the total number of questions increases, the target number of questions can be set to make more difference. Nevertheless, if the display on the one region is provided with an image having a size corresponding to each number of questions so that the corresponding ratio can be checked, the learner may not perceive that the larger number of questions actually increases as compared to the target number of questions which actually increases, and as a result, there is an effect of inducing the learner to solve the larger number of questions.

Meanwhile, referring again to FIG. 11, the UI generation unit 130 may display one or more text objects including character text, picture text, or voice text on a first content display region 250 of the webpage, and may display one or more question objects composed of questions and/or options on a second content display region 270 adjacent to one side of the first content display region 250.

In the embodiment of FIG. 11, a voice text object 251a and a picture text object 253 are displayed on the first content display region 250 of the webpage, and four options each described as “mark your answer” without any specific question content are displayed on the second content display region 270.

The UI generation unit 130 may float the progress request button 290 at a lower end of the webpage. The progress request button 290 may be a button for receiving a progress input to a next page, and may be displayed on an upper layer or may be floated at an upper end of the first content display region 250 or the second content display region 270 without a layer. In a responsive webpage, the progress request button 290 may be set to be fixedly displayed at a lower center of the webpage displayed according to the size of a web browser.

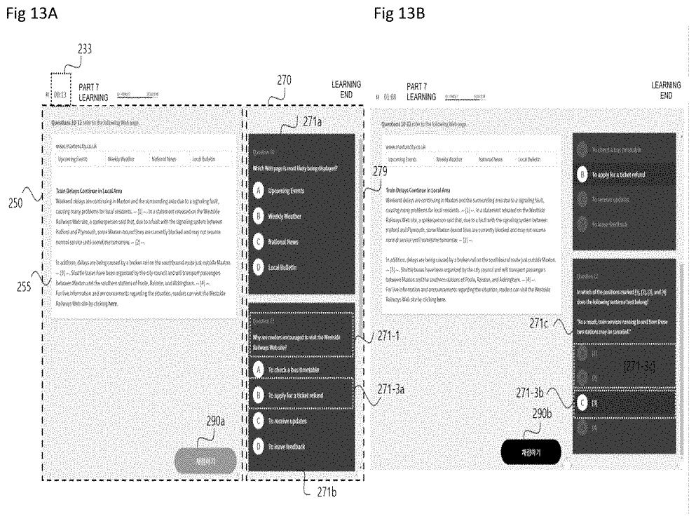

In addition, when the one or more text objects or the one or more question objects are not displayed at a time on each of the content display regions 250 and 270, the UI generation unit 130 may activate scroll bars 259 and 279 located at one side surface of each region. That is, each of the content display regions 250 and 270 operate independently, and when the text objects are displayed at a time but the question objects are not displayed at a time as shown in FIG. 13, the text object desired to be identified may be adjusted to be displayed on the second content display region 270, using the activated scroll bar 279.

Hereinafter, in various embodiments, contents displayed on the webpage by the UI generation unit 130 will be described in more detail.

### Question Solving Mode

Hereinafter, the question solving mode will be described in more detail with reference to FIG. 13.

Referring to FIG. 13, the UI generation unit 130 may count the question solving time in the one fixed region 233 of the upper end of the webpage in the question solving mode. The question solving time may be counted up or counted down at a predetermined time.

In the example of FIG. 13, a text object 255 including one block of character text may be displayed on the first content display region 250, and one or more question objects may be displayed on the second content display region 270. The question shown in FIG. 13 is a combination question in which 3 questions are associated with one block of text, and 3 question objects 271a, 271b, and 271c are displayed.

A question 271-1 and an option 271-3 may be displayed on each question object 271. FIG. 13A is a diagram illustrating a case in which no question is solved, and FIG. 13B is a diagram illustrating a case in which all the questions are solved, that is, a learner selects all the answers. In FIG. 13A, a plurality of options included in the question object 271 are all displayed in the same manner. When the learner selects any one of the plurality of options, the UI generation unit 130 may set the remaining options except for the selected option to be deactivated and displayed as indicated by 271-3c.

In addition, when option selection for all the displayed question objects is completed, the progress request button displayed as indicated by 290a in FIG. 13A may be activated using a bar 290b shown in FIG. 13B. This means that the learner cannot practically proceed to the next step without selecting all the answers, and can proceed to the next step only when the learner selects all the answers as shown in FIG. 13B.

Text such as “scoring” may be displayed on the progress request button 290 in the question solving mode, but the present disclosure is not limited thereto.

### Scoring Mode

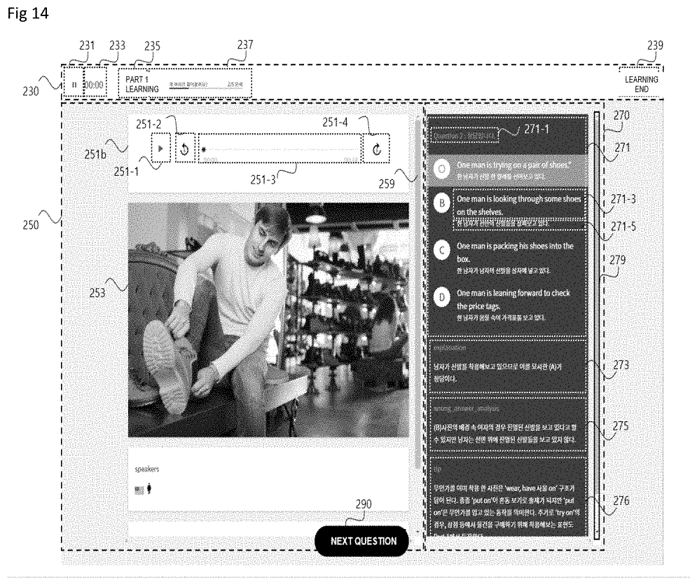

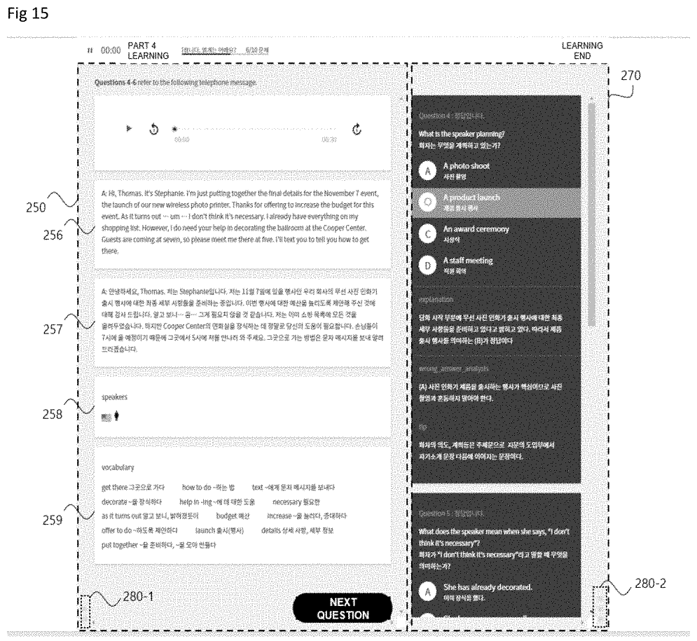

FIGS. 14 and 15 are diagrams illustrating a configuration displayed on a webpage in a scoring mode. Referring to FIG. 14, the UI generation unit 130 may set the question solving time on the one region 233 so as not to be counted in the scoring mode.

The scoring mode is a mode switched when the learner clicks on the progress request button 290 in the question solving mode, and is a kind of learning mode that provides the result of the answer input by the learner and enables learning based on the solved question. Text such as “next question” may be described on the progress request button 290 in the scoring mode.

The question shown in FIG. 14 is a question of the same type as that in FIG. 11 in which the question is solved by referring to pictures and voice. In the question solving mode as shown in FIG. 11, voice text is reproduced using a player 251b. In the scoring mode shown in FIG. 14, a player 251b includes a play or pause button 251-1 and buttons 251-2 to 251-4 providing a play point setting function, and can provide the above-described functions.

In the scoring mode, the UI generation unit 130 may further display, on the first content display region 250, at least one of voice text 251a displayed in the question solving mode, picture text 253, interpretation of character text additionally to the character text 255, a script of the voice text, interpretation of the script, speaker information of the voice text, and word information included in the character text or the script.

For example, when voice text is provided as shown in FIG. 15 and a question is provided based on the provided voice text, a script 256 of the voice text, interpretation 257 of the script, speaker information 258 of the voice text such as whether the speaker of the voice text is the American, British, or Australian, and word information 259 included in the character text or the script may be added to the first content display region 250. This allows the learner to identify the details of the listening question and to grasp the contents more clearly.

In addition, the UI generation unit 130 may further display at least one of whether the corresponding answer is correct or incorrect in addition to questions and/or options displayed on the second content display region 250 in the question solving mode, interpretation of the questions, interpretation of the options, interpretation of question objects, incorrect answer analysis information about the question object, and information about the type of the question object.

Referring to FIG. 14, whether the answer is correct or incorrect may be additionally displayed in the question 271-1, and interpretation 271-5 about each option may be additionally displayed below the option 271-3. In addition, interpretation 273 about the question object, incorrect answer analysis information 275, and information 276 about the type of the question object may be additionally displayed at a lower end of the question object 271. Type information of the question object is a tip related to the corresponding question and may include information that the learner can refer to when solving a similar type of question in the future. This additional content is stored in the storage unit 150, and content may be selectively added and applied depending on whether a user selection is correct or incorrect.

In FIG. 15, a small rectangular image 280-2 is displayed at a lower end at one side of each of the first content display region 250 and the second content display region 270. This means the number of text objects or question objects displayed in each region. For example, in the example of FIG. 15, since a combination question in which voice text is associated with 3 questions is provided, 3 question objects from question 4 to question 6 are displayed on the second content display region. The number of objects displayed in the region may be an indicator 280 that guides the learner to avoid missing text or question, and may be displayed as characters, figures, or numbers.

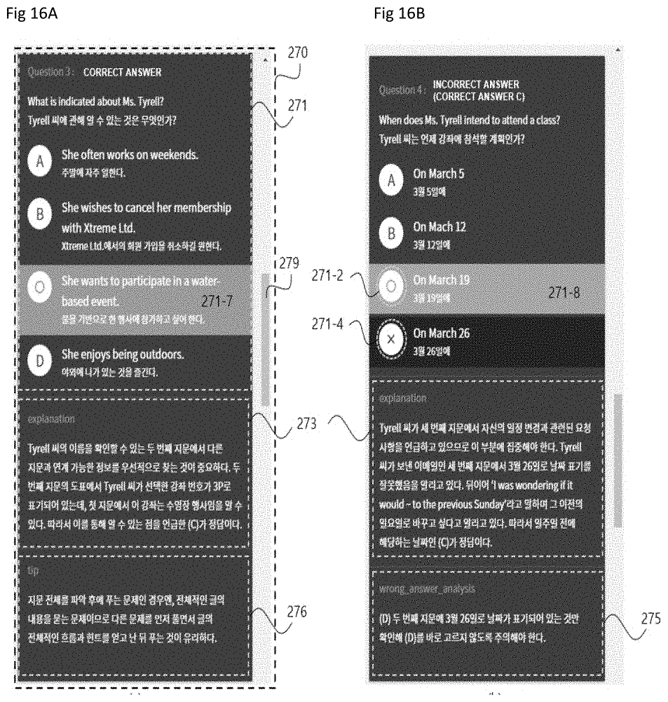

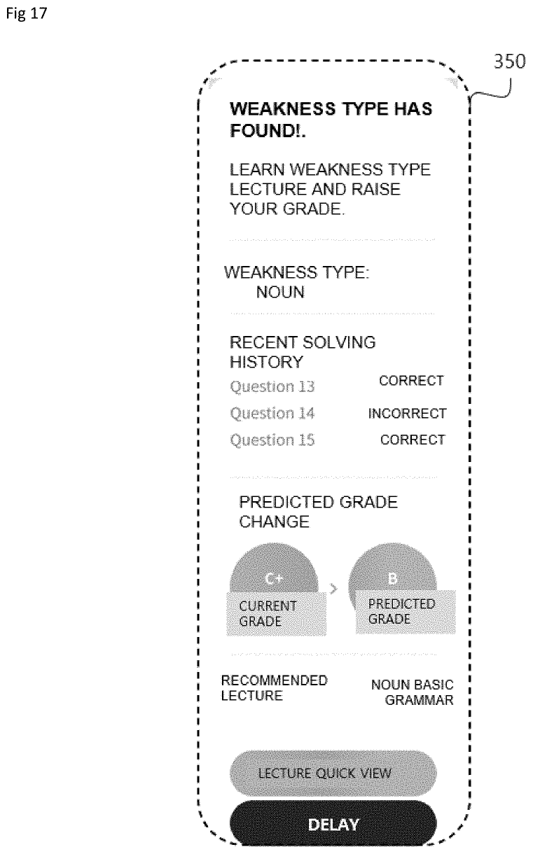

FIG. 16 illustrates an embodiment of a case in which information displayed in the second content display region varies depending on whether an option selected by a learner is correct or incorrect.

When a first option 271-7 selected by a learner in the question solving mode is correct as shown in FIG. 16A, the UI generation unit 130 may display the type information 276 of the question object at a lower end of the question object, and may display the first option included in the question object in a second color (blue), as the correct answer indicated by 271-7.

Next, when the first option 271-4 selected by the learner in the question solving mode is incorrect, the UI generation unit 130 may display incorrect answer analysis information at the lower end of the question object, may display the first option included in the question object as the incorrect answer indicated by 271-4, and may display an option 271-2 corresponding to the correct answer in a predetermined first color (red) as indicated by 271-8.

By displaying the option corresponding to the correct answer in different colors according to whether the option is correct or incorrect, the present disclosure has an effect of enabling the learner to more intuitively recognize a question of which the answer of the learner is incorrect.

The communication unit 170 may transmit the learning content generated by the UI generation unit 130 to the terminal 50 of the learner, so that the learner may perform learning using the content displayed in the above-described method.

Hereinafter, a method for providing questions for learning according to an embodiment of the present disclosure will be briefly described. In an example described below, some duplicated descriptions will be omitted. The method for providing questions for learning is divided into steps such as step f or step g, but they are to distinguish each piece of display content and are not performed sequentially. Therefore, it should be noted that the flowchart is not separately described in this specification because the steps are not constrained in the order thereof.

A method by which a server provides questions for learning according to an embodiment of the present disclosure displays a question solving time on one fixed region of an upper end of a webpage in step f. The displayed question solving time may be counted in a question solving mode, but may not be counted in a scoring mode.

The server may display a predetermined first target number of questions versus the number of solved questions on the one fixed region of the upper end of the webpage in step g. In this step, the server may compare the number of solved questions and the first target number of questions when a progress request button is selected, and may switch and display the display on the one region to a predetermined second target number of questions versus the number of solved questions when the number of solved questions achieves or exceeds the first target number of questions based on the comparison result. In this case, the server may display the first target number of questions versus the number of solved questions as an image having a size corresponding to each number of questions, so that the learner can intuitively recognize the target number of questions versus the number of solved questions.

The server may display one or more text objects including character text, picture text, or voice text on a first content text region of the webpage in step h. The server may display the text object on the first content display region in the question solving mode, and may further display at least one of interpretation of the character text on the first content display region, a script of the voice text, interpretation of the script, speaker information of the voice text, and word information included in the character text or the script on the first content display region.

The voice text may be output as voice through a player. Here, the player may provide a play or pause function in the question solving mode and may provide a play function, a pause function, and a play point setting function in the scoring mode.

Further, in displaying the text object on the first content display region, the server may activate a scroll bar located at one side surface of each region when the one or more text objects are not displayed on the first content display region at a time or when the one or more question objects are not displayed on a second content display region at a time.

The server may display the one or more question objects including at least one of questions or options on the second content display region adjacent to one side of the first content display region in step i. When the learner selects any one of the options in the question solving mode, the server may deactivate and display the remaining options except for the selected option, and may further display at least one of whether the corresponding answer is correct or incorrect in the scoring mode, interpretation of the questions, interpretation of the options, interpretation of the question objects, incorrect answer analysis information about the question objects, and information about the type of the question objects.

In step i, when a first option selected by the learner in the question solving mode is incorrect, the server may display incorrect answer analysis information at a lower end of the question object in the scoring mode, may display the first option included in the question object as the incorrect answer, may display the option corresponding to the correct answer in a predetermined first color, and may display the first option in a second color different from the first color when the first option is correct.

In step j, the server may float a progress request button at the lower end of the webpage. In the question solving mode, the server may activate the progress request button when selection for all of the displayed question objects is completed.

In addition, the server may display the number of text objects at one side surface of the first content display region or may display the number of question objects at one side surface of the second content display region. These numbers of objects may be displayed by indicators such as characters, numbers, or figures.

Some embodiments omitted in this specification are equally applicable if their implementation subjects are the same. It will be apparent to those skilled in the art that various modifications and variations can be made in the present disclosure without departing from the spirit or scope of the disclosure. The present disclosure is not limited to the above-described embodiments and the accompanying drawings.

1. A method by which a server provides questions for learning, the method comprising:
step a of displaying learning content on a first region of a screen displayed on a terminal of a learner;
step b of fixedly displaying an AI object on a second region of the screen;
step c of determining whether a learning progress of the learner satisfies a predetermined object activation condition; and
step d of displaying an AI message corresponding to the object activation condition on a third region of the screen adjacent to the AI object while the AI object is activated, when the learning progress satisfies the object activation condition.

2. The method as claimed in claim 1, wherein step c comprises determining that the learning progress satisfies the object activation condition when the display on the first region is changed by a learner input received from the terminal, and
step d comprises displaying, on the third region, an AI message corresponding to the display on the first region.

3. The method as claimed in claim 1, wherein step c comprises
determining that the learning progress satisfies the object activation condition when a learning result of the learner is changed by a learner input received from the terminal,
wherein the learning result includes a predicted score calculated using a question solving result of the learner, whether the predicted score reaches a predetermined goal score, whether the question solving result of the learner is correct or incorrect, achievement for each learning area of the learner calculated using the question solving result of the learner, grade information of the learner calculated using the question solving result of the learner, or a correct answer probability of a next question calculated using the question solving result of the learner.

4. The method as claimed in claim 1, wherein step d comprises
sequentially displaying one or more AI messages corresponding to the condition on the third region in accordance with a predetermined priority, the AI message including one or more action objects receiving a learner input,
the method further comprising:
step e of deactivating the AI object when an input of selecting a first action object for deactivating the AI object is received from the terminal, and of displaying, when an input of selecting a second action object corresponding to first learning content stored in advance in the server is received from the terminal, the first learning content on the first region.

5. The method as claimed in claim 1, wherein, when the learning content is question solving content, step c comprises
determining that a first object activation condition is satisfied when an answer to a first question is input from the terminal,
wherein the AI message corresponding to the first object activation condition includes at least one of a loading message of a next question, whether the answer is correct or incorrect, achievement for each learning area of the learner calculated using whether the answer is correct or incorrect, grade information of the learner calculated using whether the answer is correct or incorrect, a weak learning area of the learner calculated using whether the answer is correct or incorrect, a name of a recommended lecture corresponding to the weak learning area, and a link of the recommended lecture.

6. The method as claimed in claim 5, wherein, when the first question is a final question of the question solving content including one or more questions, the AI message corresponding to the first object activation condition includes at least one of a solving result statistic and a completion message of the question solving content.

7. The method as claimed in claim 1, wherein step c comprises
determining whether a diagnostic test result of the learner exists in a database when a learner input is a new question learning request, and
determining that a second object activation condition for inducing a diagnostic test is satisfied when the diagnostic test result of the learner does not exist in the database,
wherein an AI message corresponding to the second object activation condition includes a message for inducing the diagnostic test and an action object executing the diagnostic test.

8. The method as claimed in claim 1, wherein step c comprises
determining that a third object activation condition is satisfied when a new learning content start input is received from the terminal in a state in which first learning content that has not been completed exists,
wherein an AI message satisfying the third object activation condition includes a message for inducing learning of the first learning content and an action object executing the first learning content.

9. The method as claimed in claim 1, wherein, when the learning content is question solving content, step c comprises
displaying a random question on the first region, and determining that a fourth object activation condition is satisfied when a time at which an answer to the question is input is less than a predetermined reference value,
wherein an AI message corresponding to the fourth object activation condition includes an alarm message about a solving speed.

10. The method as claimed in claim 1, wherein a webpage or an application program provided by the server is displayed on the screen.

11. The method as claimed in claim 1, wherein the first region is displayed on a layer different from those of the second region and the third region.

12. The method as claimed in claim 1, further comprising:
step f of displaying a question solving time on one fixed region of an upper end of the screen;
step g of displaying a predetermined first target number of questions versus the number of solved questions on the one fixed region of the upper end of the screen;
step h of displaying one or more text objects including character text, picture text, or voice text on a first content display region located at one side of the first region;
step i of displaying one or more question objects including at least one of questions and options on a second content display region adjacent to the first content display region; and
step j of floating a progress request button at a lower end of the screen,
wherein step g comprises comparing the number of solved questions and the first target number of questions when the progress request button is selected, and switching and displaying the display on the second region to a predetermined second target number of questions versus the number of solved questions when the number of solved questions achieves or exceeds the first target number of questions based on the comparison result.

13. The method as claimed in claim 12,
wherein, in a question solving mode, step f comprises counting the question solving time, and step h comprises displaying the text object on the first content display region,
wherein step i comprises deactivating and displaying, when the learner selects one of the options, the remaining options except for the selected option, and
wherein step j comprises activating the progress request button when selection for all of the displayed question objects is completed.

14. The method as claimed in claim 12,
wherein, in a scoring mode, step f comprises not counting the question solving time, and step h comprises further displaying at least one of interpretation of the character text, a script of the voice text, interpretation of the script, speaker information of the voice text, and word information included in the character text or the script on the first content display region, and
wherein step i comprises further displaying at least one of whether an answer to the question is correct or incorrect, interpretation of the question, interpretation of the option, interpretation of the question object, incorrect answer analysis information about the question object, and information about a type of the question object.

15. The method as claimed in claim 14, wherein step i comprises
displaying, when a first option selected by the learner in a question solving mode is an incorrect answer, the incorrect answer analysis information at a lower end of the question object, displaying the first option included in the question object as being the incorrect answer, and displaying an option corresponding to a correct answer in a predetermined first color, and
displaying, when the first option is the correct answer, the first option in a second color different from the first color.

16. The method as claimed in claim 12, when the one or more text objects are not displayed on the first content display region at a time or when the one or more question objects are not displayed on the second content display region at a time, further comprising:
activating a scroll bar located at one side surface of each region.

17. The method as claimed in claim 12, wherein the voice text is output as a voice via a player, and the player provides a play function or a pause function in a question solving mode and provides the play function, the pause function, and a play point setting function in a scoring mode.

18. The method as claimed in claim 12, wherein step g comprises displaying the first target number of questions versus the number of solved questions as an image having a size corresponding to each of the number of questions.

19. The method as claimed in claim 12, further comprising:
displaying the number of the text objects on one side surface of the first content display region, or displaying the number of the question objects on one side surface of the second content display region.

20. A device for providing questions for learning, the device comprising:
a storage unit configured to store learning content, an AI object, and an AI message;
a UI generation unit configured to generate a user interface for displaying the learning content, the AI object, and the AI message in a webpage or an application program; and
a communication unit configured to transmit the learning content, the AI object, and the AI message, which are displayed according to the user interface, to a terminal of a learner,
wherein the UI generation unit
displays the learning content on a first region of a screen displayed on the terminal of the learner,
fixedly displays the AI object on a second region of the screen,
determines whether a learning progress of the learner satisfies a predetermined object activation condition when a learner input is received from the terminal, and
sets the user interface to display the AI message corresponding to the object activation condition on a third region of the screen adjacent to the AI object while the AI object is activated, when the learning progress satisfies the object activation condition.

21. The device as claimed in claim 20, wherein the UI generation unit sets the user interface to
display a question solving time on one fixed region of an upper end of the screen, display a predetermined first target number of questions versus the number of solved questions on the one fixed region of the upper end of the screen, display one or more text objects including character text, picture text, or voice text on a first content display region located at one side of the first region, display one or more question objects including at least one of questions and options on a second content display region adjacent to the first content display region, and float a progress request button at a lower end of the screen, and
compare the number of solved questions and the first target number of questions when the progress request button is selected, and switch and display the display on the second region to a predetermined second target number of questions versus the number of solved questions when the number of solved questions achieves or exceeds the first target number of questions based on the comparison result.

22. An application program for providing questions for learning, which is stored in a computer-readable medium in order to execute any one of the methods of claim 1.
